(19) United States
(12) Patent Application Publication
(10) Pub. No.: US 2014/0290281 A1
(43) Pub. Date: Oct. 2, 2014

(54) Articulated tug and barge arrangement for LNG storage, transportation and regasification

(71) Applicant: Waller Marine, Inc., (US)

(72) Inventor: David Waller, Houston, TX (US)

(73) Assignee: Waller Marine, Inc., Houston, TX (US)

(21) Appl. No.: 13/815,904

(22) Filed: Mar. 15, 2013

Related U.S. Application Data
(63) Continuation-in-part of application No. 13/167,687, filed on Jun. 23, 2011.

(51) Int. Cl. F17C 13/00

(52) U.S. Cl. CPC F17C 13/002
USPC 62/53.2

(57) ABSTRACT

Articulated tug and barge arrangements and methods for transportation, storage, and regasification of liquefied natural gas (LNG) aboard barge units and ballasting the barge units, and LNG bunker barge systems and methods for LNG bunkering, are provided.

### CROSS REFERENCE TO RELATED APPLICATIONS

This application is a continuation-in-part of and claims priority to U.S. Nonprovisional patent application Ser. No. 13/167,687, filed Jun. 23, 2011, of which the benefit of priority is claimed and the contents of which are hereby incorporated by reference.

### BACKGROUND

1. Field of the Invention

The present invention relates generally to an articulated tug and barge arrangement, and more particularly, to the transportation, storage and regasification of liquefied natural gas (LNG) aboard a barge unit and to the ballasting of the barge unit.

2. Description of Related Art

Large volumes of natural gas are produced in many remote areas of the world. Natural gas in stranded gas reserves has significant value if it can be economically transported to a market with commercial demand. When the terrain and distance permit, natural gas is often transported by submerged and/or land-based pipeline. However, it is well appreciated that where the natural gas is produced in distant locations where a pipeline is infeasible or economically prohibitive, other techniques must be developed and used to transport this gas to market.

Liquefaction of natural gas facilitates storage and transportation of the natural gas because liquefied natural gas or “LNG” takes up only about 1/600 of the volume that the same amount of natural gas does in the gaseous state. The most commonly used technique for transportation of such distant natural gas resources involves liquefying the natural gas at or near the production site and then transporting the liquefied natural gas or “LNG” to market in massive, specially designed tanker ships called LNG carriers. LNG carriers have cryogenic compartments for carrying LNG to a destination port, where the LNG is offloaded to the storage tanks of a land-based regasification facility, where it may be stored in a liquid state or regasified. It is well understood that this requires the building and maintaining of onshore storage and gasification facilities at a major financial and time-consuming expense. Furthermore, economic and regulatory events have pushed LNG to the forefront as a growing alternative bunker fuel source in the US marine fuel market. Newer environmental regulatory regimes are placing tighten emissions requirements on commercial maritime industry, requiring vessels to use drastically cleaner burning alternatives like LNG instead of the traditional maritime fuels: fuel oil and diesel. Plus, recent discoveries of abundant low cost, non-conventional shale gas deposits in the US and worldwide have created a substantial price gap between LNG and environmentally compliant diesel. Thus, utilizing LNG as a marine fuel is economically advantageous and environmentally friendly, making it a sound alternative to traditional marine bunker fuels.

For safety and ecological reasons, it has also been proposed to offload LNG in its liquid state into floating storage and regasification units (FSRUs), acting as LNG import terminals, which are typically between 350 to 400 meters long by up to 70 meters wide. LNG carriers are typically berthed and unloaded alongside the FSRU, and the LNG is stored in the FSRU's storage tanks. It is equally understood that building and maintaining FSRUs is an expensive and time consuming process and that relocation of FSRUs is slow, expensive and not common due to their physical limitations.

U.S. Pat. No. 7,047,899, issued to Laurilehto et al., discloses a pusher-barge system in which a tug unit is supplied power by a barge unit by energy generated by LNG boil off gas on the barge unit. U.S. Pat. No. 6,089,022, issued to Zednik et al., discloses a method for regasification onboard an LNG carrier before transferring the gas to an onshore facility. U.S. Pat. No. 7,293,600, issued to Nierenberg, discloses an LNG carrier with a heat exchanger partially submerged in surrounding seawater. Thus while it has been proposed that regasification take place onboard an LNG carrier, financial and accessibility limitations remain major disadvantages.

It has also been proposed that when the regasification facility is located onboard an LNG carrier, the source of heat used to regasify the LNG may be through the intake and discharge of seawater in the vicinity of the LNG carrier. However, discharging of the chilled seawater into the vicinity of the LNG carrier can have an undesirable impact on the environment and certain regulations now preclude the use of such an open loop system.

It is thus a principal object of the present invention to provide a new system and method for storing, transporting and regasifying LNG, which is more economically feasible, environmentally friendly and in accord with regulations.

Methods and systems of the present invention achieve aforementioned objects and goals by effectively replacing the storage tanks of the loading and discharging ports, thereby eliminating or minimizing the cost of otherwise necessary infrastructure.

Methods and systems of the present invention achieve aforementioned objects and goals by providing an efficient, closed loop means for regasifying LNG using the inherent heat in seawater in conjunction with ballasting operations.

The Daewoo patent WO Pat. No. 2011/046315 discloses a self propelled ship for bunkering liquefied fuel gas to a liquefied fuel gas propulsion ship; however financial, logistical and accessibility limitations remain as major disadvantages. It is thus the principle object of the present invention to provide a new system and method for transporting, storing and bunkering LNG, which is more adaptable, economically feasible.

To overcome the limitations of the prior art described above, and to overcome other limitations that will become apparent upon reading and understanding the present specification, embodiments of the present invention provide a cost effective method and simplified means for transportation and regasification of LNG as well as an economically and environmentally acceptable way of regasifying LNG and performing ballasting operations.

In addition, floating power production facilities, otherwise known as power generation barges or floating power plants (“FPPs”), are considered highly suitable and economically effective means for providing transportable power in the form of electricity to hard-to-reach regions of the world. FPPs were initially conceived as a means of monetizing stranded offshore natural gas, while simultaneously permitting offshore oil production in the deep waters of the world. Interest is now being shown to generate electrical power offshore in order to reduce the need for lengthy permitting applications needed for land based power plants.

Moreover, FPPs may often be the only suitable means for power generation due to geographic and topographic restrictions precluding land-based power systems. In the operation of FPPs, greater consideration is being given to emissions and different fuels, particularly as the cost of oil increases to higher levels. Natural gas is considered a highly efficient and clean fuel for the operation of FPPs, yet the cost of supplying natural gas to FPPs such as through the construction and operation of new natural gas pipelines may prove uneconomical, and thus a needs exists for a system for transporting, storing and regasifying LNG for supply to FPPs.

Since FPPs are typically not designed to sit in waters that are aggravated by waves but rather are normally designed for services in protected inland waters such as rivers, lagoons or small ports, FPPs are often not accessible by conventional large LNG carriers. Accordingly a need therefore exists for an efficient and economically sound system for transporting, storing and regasifying LNG for supply to floating power production facilities. Embodiments of the present invention are particularly suited to transport, store and supply fuel to floating power production facilities and thus satisfy these and other objects.

### SUMMARY

The following present a simplified summary of the present disclosure in a simplified form as a prelude to the more detailed description that is presented herein.

The present invention is directed to an articulated tug and barge arrangement, to a method for transporting and regasifying LNG (liquefied natural gas) aboard a barge unit, to a method for storing LNG, and to a method for regasification aboard and ballasting of a barge unit.

In one aspect, the present invention relates to an articulated tug and barge arrangement for transporting and regasifying LNG. The articulated tug and barge arrangement comprises a tug unit and a barge unit for conveying and regasifying a load of LNG, the barge unit comprising at least one type C tank for conveying the load of LNG under pressure, a gas combustion unit operatively coupled to the type C tank for the management of over pressurized gas within the type C tank, and at least one regasification unit fluidly coupled to receive LNG from said type C tank for regassifying LNG aboard the barge unit. The tug unit is operatively coupled to the barge unit and has a propulsion system capable of propelling the barge unit such that the tug unit may propel the barge unit and thus the load of LNG from a supply terminal to a desired location such as a natural gas pipeline or an offshore floating power production facility. In preferred embodiments, the present invention relates to an articulated tug and barge arrangement and method for transporting and storing LNG aboard a barge unit and to regasifying LNG aboard the barge unit.

In one embodiment of the present invention, the barge unit comprises at least one ballast tank having ballast water and the regasification unit is fluidly coupled to the at least one ballast tank such that the ballast water may be circulated from the ballast tank through a heat exchanger disposed within said regasification unit to warm and regasify the LNG.

In another embodiment of the present invention, the barge unit further comprises at least one ballast tank for the containment of ballast water, and the regasification unit is fluidly coupled to a water inlet disposed along the exterior surface of said barge unit such that water may be withdrawn from the body of water surrounding said barge unit and circulated through a heat exchanger disposed within the regasification unit to warm and regasify the LNG; and the regasification unit is also fluidly coupled to the at least one ballast tank such that water may be flowed from the regasification unit into said ballast tank for ballasting operations of the barge unit.

Preferably, the barge unit further comprises a means for heating the ballast water. For instance, a second heat exchanger and a third heat exchanger fluidly coupled to a boiler may be provided aboard the barge unit for heating the ballast water. The second heat exchanger may be configured such that water from the water inlet is heated by steam from a boiler prior to circulation of the water through the regasification unit. The third heat exchanger may be configured such that chilled water flowing from the regasification unit would be heated prior to circulation into the ballast tanks.

In another embodiment, the propulsion system of the tug unit is powered by LNG.

In yet another embodiment, the barge unit further comprises a nitrogen injection system fluidly coupled to the send-out piping that is fluidly coupled to the regasification unit aboard the barge unit for adjustment of the calorific value of the natural gas being transferred to off board facilities such as a natural gas pipeline or an offshore floating power production facility.

In another aspect, the present invention relates to a method for transporting and regasifying liquefied natural gas (LNG) aboard an articulated tug and barge arrangement wherein said tug and barge arrangement comprises a tug unit operatively coupled to a barge unit having at least one type C tank, and the method comprises loading LNG directly from a liquefaction plant into the or each type C tank disposed within the barge unit, employing the tug unit to propel the barge unit from the liquefaction plant to an off board facility, regasifying the LNG aboard the barge unit, and transferring the natural gas to the off board facility. In embodiments of the present invention, the off board facility may be an offshore floating power production facility, a natural pipeline, and/or an onshore power production facility.

In yet another aspect, the present invention relates to a method for transporting and regasifying liquefied natural gas (LNG) aboard an articulated tug and barge arrangement and fueling an offshore power production facility, wherein said tug and barge arrangement comprises at least one barge unit having at least one type C tank and a tug unit operatively coupled to the at least one barge unit, and the method comprises loading LNG directly from a liquefaction plant into the or each type C tank disposed within the barge unit, employing the tug unit to propel the barge unit from the liquefaction plant to a floating power production facility, regasifying the LNG aboard the barge unit, and supplying fuel to said floating power production facility for power generation.

In another aspect, the present invention relates to a method of regasifying liquefied natural gas (LNG) aboard a barge unit and ballasting said barge unit, where the method comprises withdrawing seawater from the body of water surrounding said barge unit and flowing said seawater through a regasification unit which is positioned aboard said barge unit for the heating and regasification of LNG, flowing said seawater from the regasification unit into ballast tanks disposed within the barge unit for the ballasting down of the barge unit, flowing LNG from type C tanks disposed within the barge unit for storing LNG during transport through said regasification unit to heat and transform said LNG into natural gas within said regasification unit, and transferring natural gas from the regasification unit to off board facilities. Preferably, the method further comprises heating the seawater.

In another aspect, the present invention relates to a method for regasifying liquefied natural gas (LNG) aboard a barge unit and ballasting said barge unit, said barge unit having at least one ballast tank for the containment of water and at least one type C tank for the containment of LNG, and wherein the barge unit has at least one regasification unit fluidly coupled to the at least one ballast tank and to the at least one type C tank, and the method comprises the steps of introducing water into the at least one ballast tank of the barge unit, directing said water from the ballast tank through at least one heat exchanger disposed within said regasification unit for the regasification of LNG to a gaseous state, unloading said natural gas from the barge unit, directing said water from the heat exchanger to at least one ballast tank, and allowing the barge unit to ballast while unloading natural gas from the barge unit. Preferably, the method comprises heating the ballast water.

By regasifying LNG aboard the barge unit before it is off-loaded from the barge unit to desired facilities such as a natural gas pipeline or an offshore floating power production facility, the need for onshore LNG storage tanks is eliminated thereby allowing transportation and deployment of LNG to markets that would not otherwise be available due to restrictions such as size preventing the use of conventional LNG carriers. Moreover, by using ballast water as a primary heat exchange medium for the onboard regasification units, embodiments of the present invention provide an environmentally-friendly method and system, by safely and efficiently enabling regasification and unloading operations without discharge to surrounding seawater while providing necessary ballast water to the barge unit offsetting respective displacements.

Embodiments of the present invention are directed toward an articulated tug and barge arrangement for transporting and storing liquefied natural gas (LNG) and bunkering liquefied natural gas to a liquefied natural gas fueled ship; the articulated tug and barge arrangement comprising: a tug unit comprising a propulsion system; a barge unit for conveying and storing and bunkering a load of LNG, the barge unit comprising at least one type C tank for conveying and storing the load of LNG under pressure, a gas combustion unit operatively coupled to the type C tank for the management of over pressurized boil-off gas within the type C tank, and an at least one liquid manifold fluidly coupled to bunker LNG from the type C tank to the liquefied natural gas fueled ship; wherein said tug unit is operatively coupled to said barge unit for propelling said barge unit from one location to another.

In another embodiment, the barge unit further comprising an at least one regasification unit fluidly coupled to receive LNG from said type C tank for regasifying LNG aboard the barge unit.

In another aspect of the articulated tug and barge arrangement, the barge unit further comprising at least one ballast tank having ballast water and at least one regasification unit fluidly coupled to the at least one ballast tank such that the ballast water may be pumped from the ballast tank through a heat exchanger disposed within a regasification unit to warm and regasify the LNG.

In yet another embodiment of the articulated tug and barge arrangement of the present invention, the barge unit further comprises at least one ballast tank for the containment of ballast water and at least one regasification unit is fluidly coupled to a water inlet disposed along the exterior surface of said barge unit such that water may be withdrawn from the body of water surrounding said barge unit and circulated through a heat exchanger disposed within said regasification unit to warm and regasify the LNG; and wherein the regasification unit is fluidly coupled to the at least one ballast tank such that water may be flowed from said regasification unit into said ballast tank for ballasting operations.

In yet another aspect, the articulated tug and barge arrangement further comprises an attachment means for operatively connecting the tug unit to the barge unit.

In yet another aspect, the propulsion system of the tug unit is powered by LNG.

In yet another aspect of the articulated tug and barge arrangement, wherein the barge unit further comprises a nitrogen injection system fluidly coupled to a regasification unit by high pressure piping for adjustment of the calorific value of natural gas unloaded from the barge unit.

In another embodiment, the present invention relates to a tug and barge arrangement for transporting and storing and transferring liquefied natural gas (LNG) to an off board facility, the tug and barge arrangement comprising: a tug unit comprising a propulsion system; a barge unit for conveying and transferring a load of LNG to the off board facility for fueling said off board facility, the barge unit comprising at least one type C tank for transporting the load of LNG under pressure, a gas combustion unit operatively coupled to the type C tank for the management of over pressurized boil-off gas within the type C tank, and at least one liquid manifold fluidly coupled to supply LNG from said type C tank to the off board facility; wherein said tug unit is operatively coupled to said barge unit for propelling said barge unit from one location to another. In one aspect of the present invention, the off board facility is a ship fueled by LNG. In yet another aspect, the off board facility receives the liquefied natural gas as bunker fuel. In yet another aspect, the tug is operatively coupled to said barge unit in an articulated manner. In yet another aspect tug is operatively coupled to said barge unit in a push-barge manner.

In another aspect, the present invention relates to a method for transporting and storing liquefied natural gas (LNG) aboard an articulated tug and barge arrangement wherein said tug and barge arrangement comprises a tug unit operatively coupled to a barge unit having at least one type C tank, said method comprising: loading LNG directly from a liquefaction plant into the or each type C tank disposed within the barge unit; employing the tug unit to propel the barge unit from the liquefaction plant to a destination of an off board facility; storing the LNG within the or each type C tank disposed within the barge unit at the destination of the off board facility; and transferring the LNG to the off board facility as fuel. In one embodiment, the off board facility is a ship fueled by LNG. In another embodiment, the off board facility is a ship fueled by natural gas. In yet another embodiment, the off board facility is a ship fueled by natural gas, said ship having a regasification for the regasification of LNG onboard the ship. In yet another embodiment, the off board facility is a floating power production facility. In one embodiment, the method, the step of storing the LNG within the or each type C tank lasts up to 21 days. In another embodiment, the method further comprises stacking two or more barge units at the destination of the off board facility for while storing the LNG within the or each type C tank disposed within respective barge units. In yet another embodiment, the method further comprises allowing the barge unit to receive ballast while transferring the LNG to the off board facility.

In another aspect, the present invention relates to a method for transporting and bunkering liquefied natural gas (LNG) fuel to a ship, said method comprising: loading LNG directly from a liquefaction plant into an at least one type C tank disposed within a barge unit for storing and transporting said LNG; employing a tug unit to operatively couple said barge unit to propel the barge unit from the liquefaction plant to the ship; unloading LNG from the at least one type C tank disposed within the barge unit; and bunkering LNG from the barge unit to the ship for supplying said ship with LNG fuel. In one embodiment, the method further comprises stacking two or more barge units at a destination of the ship while storing the LNG within the or each type C tank disposed within respective barge units.

In another aspect, the present invention relates to a method for transporting and bunkering liquefied natural gas (LNG) fuel to a ship, said method comprising loading LNG directly from a liquefaction plant into an at least one membrane tank having a boil off gas management system disposed within a barge unit for storing and transporting said LNG; employing a tug unit to operatively couple said barge unit to propel the barge unit from the liquefaction plant to the ship; unloading LNG from the at least one membrane tank disposed within the barge unit; and bunkering LNG from the barge unit to the ship for supplying said ship with LNG fuel.

In one embodiment, the present invention relates to such method further comprising stacking two or more barge units at a destination of the ship while storing the LNG within the or each membrane tank disposed within respective barge units.

### BRIEF DESCRIPTION OF THE DRAWINGS

Illustrative embodiments of the present invention are described herein with reference to the accompanying drawings, in which:

FIG. 1 is a top plan view of a general arrangement of one embodiment of an articulated tug and barge arrangement, illustrating the barge unit having four bi-lobe type C tanks.

FIG. 2 is an elevation view of a general arrangement of one embodiment of an exemplary barge unit.

FIG. 3 is a top plan view of a general arrangement of one embodiment of an exemplary barge unit.

FIG. 4A is a cross section of one embodiment of an exemplary barge unit having bi-lobe type C tank.

FIG. 4B is another cross section of one embodiment of an exemplary barge unit having bi-lobe type C tanks.

FIGS. 5 through 6-2 show example operations of a transportation system employing articulated tug and barge arrangement and push-barge tug and barge arrangement according to the present invention.

FIG. 5-2A is an enlarged, top plan view of a general arrangement of one embodiment of the present invention illustrating elements of the barge unit as shown in the exemplary operations of the transportation system of FIG. 5-2 according to the present invention.

FIG. 7 shows example operations of a storage and fueling system employing articulated tug and barge units according to the present invention.

FIG. 8 is a schematic of a ballast and regasification system according to an embodiment of the present invention.

FIG. 9 is a schematic of a ballast and regasification system according to a preferred embodiment of the present invention.

FIG. 10 is a top plan view of a general arrangement of one embodiment of an exemplary floating power barge and regasification vessel having LNG storage.

FIG. 11 is a top plan view of a general arrangement of one embodiment of an exemplary floating power barge and regasification vessel having LNG storage.

FIG. 12 is a top plan view of a general arrangement of one embodiment of an exemplary floating power barge and regasification vessel having LNG storage.

### DETAILED DESCRIPTION

Persons of ordinary skill in the art will realize that the following disclosure is illustrative only and not in any way limiting. Other embodiments of the disclosure will readily suggest themselves to such skilled persons having the benefit of this disclosure.

The present disclosure is directed to embodiments of an articulated tug and barge arrangement and methods for transporting, storing and regasifying LNG (liquefied natural gas) aboard a barge unit and a method for regasifying aboard and ballasting down a barge unit.

For natural gas to be transported by sea, natural gas is typically liquefied into liquid form. This is known as liquefied natural gas or LNG. LNG is typically stored at a liquefaction facility in storage tanks, at which point it may be transferred to an LNG carrier for transport. Upon arrival at a destination, the LNG cargo is typically transferred to storage tanks at a terminal facility. Thereafter, the LNG is regasified back into natural gas and is transferred to a natural gas pipeline for distribution to a gas network and to consumers.

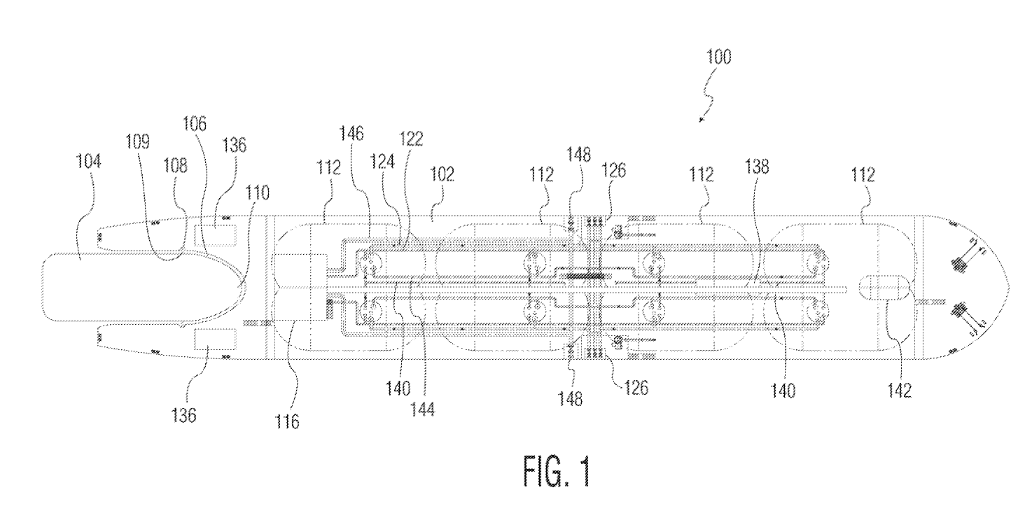

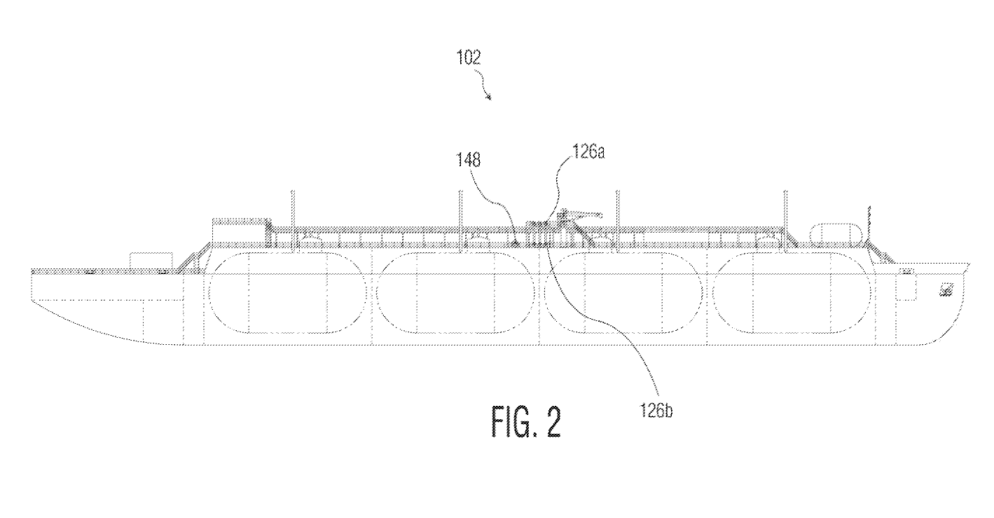

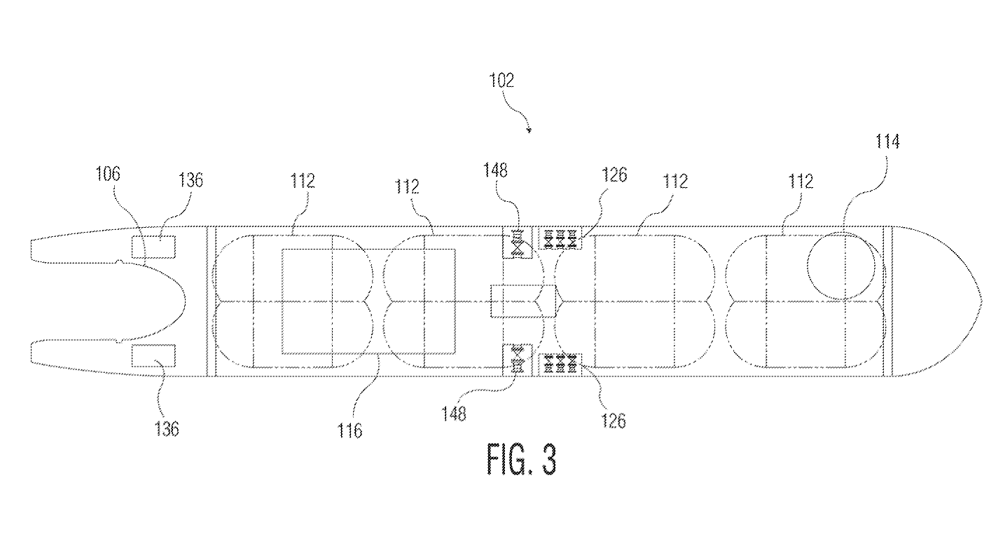

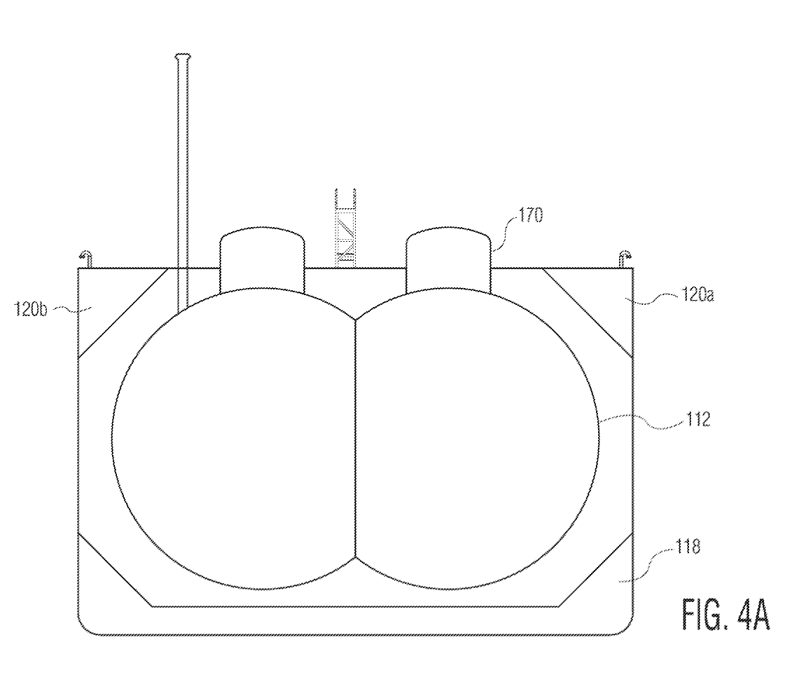

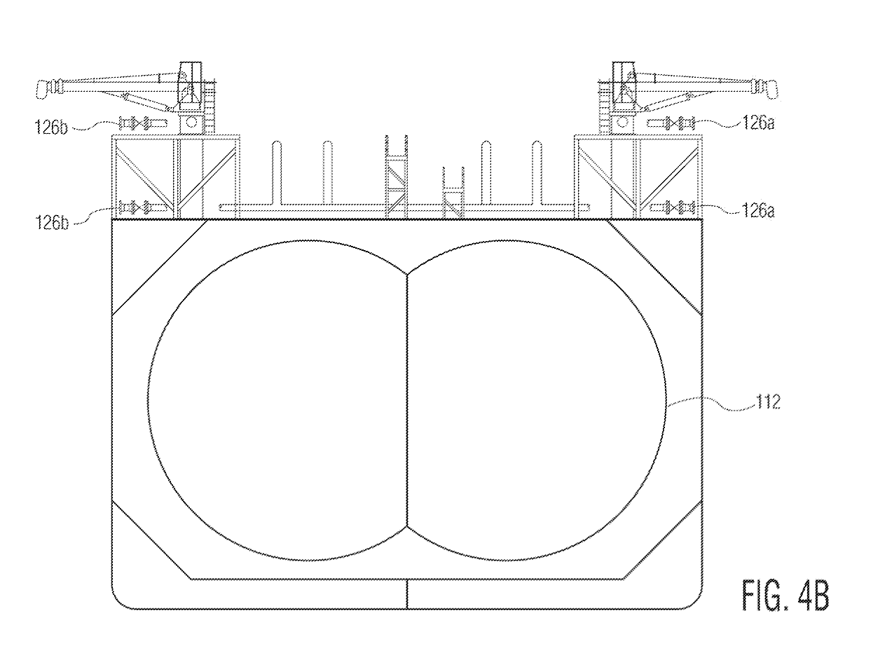

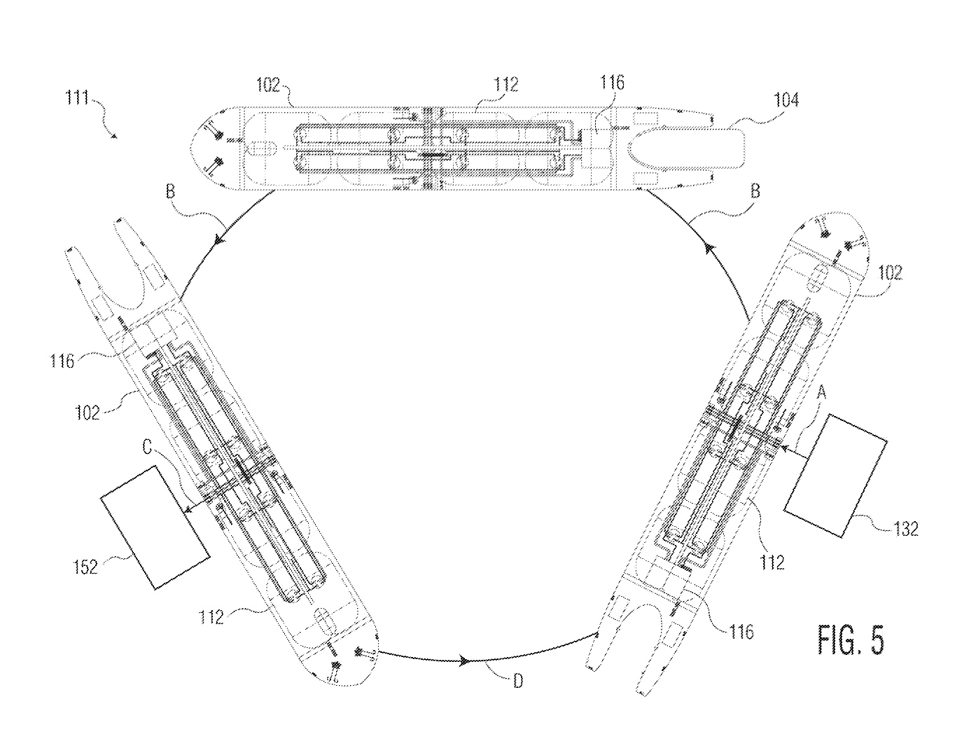

Referring initially to FIG. 1, FIG. 2, FIG. 3, FIG. 4A and FIG. 4B, the basic constructional details, principles of operation and arrangement of an exemplary articulated tug and barge arrangement 100 according to a preferred embodiment of the present invention will be discussed.

In FIG. 1, an articulated tug and barge arrangement 100 according to a preferred embodiment of the present invention is provided. In FIG. 1, the articulated tug and barge arrangement 100 comprises a barge unit 102 operatively connected to a tug unit 104 having a propulsion system for propelling the barge unit 102. The articulated tug and barge arrangement 100 is in the form of a single-degree-of-freedom system, in which the barge unit 102 has an aft notch 106 with a recess 108 for receiving a front end 110 of the tug unit 104 with a pin connection 109, thereby allowing quick connect and release operation between the tug unit 104 and barge unit 102 and combining good economics of tugboat and barge operation with the speed and weather-ability of a ship.

While the articulated tug and barge arrangement 100 in FIG. 1 is according to a preferred embodiment of the present invention, it can be appreciated that other forms of barge arrangements may be used.

The barge unit 102 comprises at least one type C tank 112 for conveying a load of LNG under pressure, a gas combustion unit 114 operatively coupled to the type C tank 112 for the management of over pressurized boil-off gas within the type C tank 112, and at least one regasification unit 116 fluidly coupled to receive LNG from said type C tank 112 for regassifying LNG aboard the barge unit 102. In one embodiment, the barge unit 102 comprises a dome 170 disposed atop a type C tank 112 for the collection of boil-off gas, and the dome 170 has a small boil-off gas vapor header fluidly coupled to a gas compressor, for allowing for pressure reduction within the type C tank 112. This is an economic and effective means of controlling the cargo tank pressure while the barge is at a discharging location.

As will be understood by those skilled in the art, it is common practice to transport LNG in LNG receptacles aboard an LNG carrier, typically ranging in capacity from 100,000 m³ to 160,000 m³, and when the LNG carrier reaches its destination, the LNG is offloaded (at typical rates of 10,000-12,000 cubic meters per hour (m³/hr)) in its liquid state onto shore where it is stored and thereafter revaporized before sending it on to end users as a gas. It is well understood that this requires the building and maintaining of onshore storage and gasification facilities at a major financial and time-consuming expense. It has also been proposed to offload LNG in its liquid state into floating storage and regasification units (FSRUs), acting as LNG import terminals, which are typically between 350 to 400 meters long by up to 70 meters wide. LNG carriers are typically berthed and unloaded alongside the FRSU, and the LNG is stored in the FSRU's storage tanks. Due to the large size of the LNG carriers, the resulting change in draft as a result of unloading cargo is typically very small and negligible. It is equally understood that building and maintaining FSRUs is an expensive and time consuming process and that relocation of FSRUs is slow, expensive and not common due to their physical limitations.

In accordance with the present invention, the articulated tug and barge arrangement 100 is relatively inexpensive to build and operate compared to the LNG carrier and FSRU. The preferred size of the barge unit 102 is up to approximately 30,000 m³. The most preferred length of the barge unit is approximately 177 meters. A type C tank 112 is a pressure vessel having a design pressure of at least 2 bar. Referring to FIGS. 1-3, in a preferred embodiment, the LNG is stored aboard the barge unit 102 in four type C tanks 112 under pressure, enabling long transport and storage of LNG aboard the barge unit 102. The type C tank 112 eliminates the need for continuous management of boil off gas, as it can, for example, sufficiently contain the LNG cargo under pressure for up to approximately twenty-one (21) days. Thus, embodiments of the present invention eliminate the need for LNG storage tanks at the destination.

Preferably, the type C tanks 112 are of bi-lobe design (FIGS. 1, 3, 4A, 4B) simply supported on insulated structural saddles such that they are not influenced by any loads emanating from the vessel hull girder during operations. A different variety of materials may be used for the type C tanks 112. The type C tanks 112 are preferably constructed of either 9% nickel steel or stainless steel AISI 304L and would be complete with swash bulkheads, stiffening rings, vapor dome, pump wells, ladders and other connections as can be appreciated by one skilled in the art. The capacity of each type C tank can vary in size but the preferred embodiment is approximately 7,500 m³. The type C tanks 112 are designed to store LNG at a temperature of approximately −163 degrees C. and at near atmospheric pressure. However, it can be appreciated that the type C tanks 112 will be capable of internal pressure calculated based upon the service profile due to a design heat input. The preferred dimensions of each type C tank 112 are approximately 25 meters in width and approximately 30 meters in length. Preferably, each type C tank is a single containment and is insulated with insulation such that boil-off is limited to a rate of approximately 0.24% of the tank capacity per day.

Referring to FIG. 1, the four type C tanks 112 are fluidly coupled to the regasification unit 116 via a liquid suction header 122, which allows the LNG to be pumped from the type C tanks 112 to the regasification unit 116 for transformation of the LNG into a gaseous state (i.e., natural gas) onboard the barge unit 102. A liquid header 124 is connected to the type C tanks 112 and configured for receipt of LNG from a supply terminal via the loading manifold 126 disposed at each side (starboard and port) of the barge unit 102.

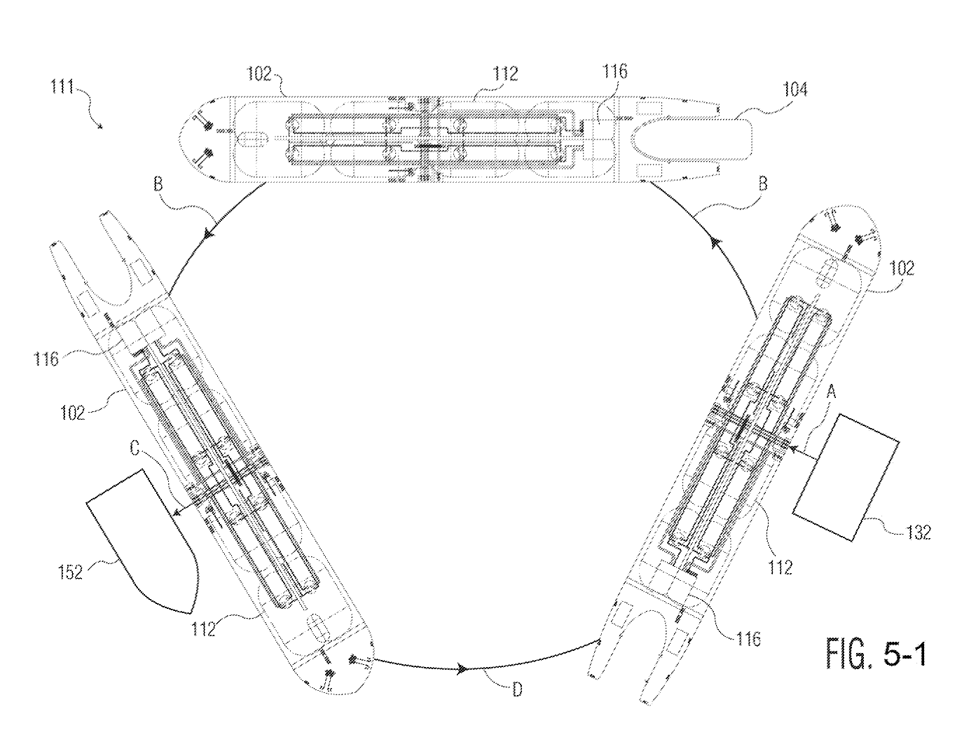

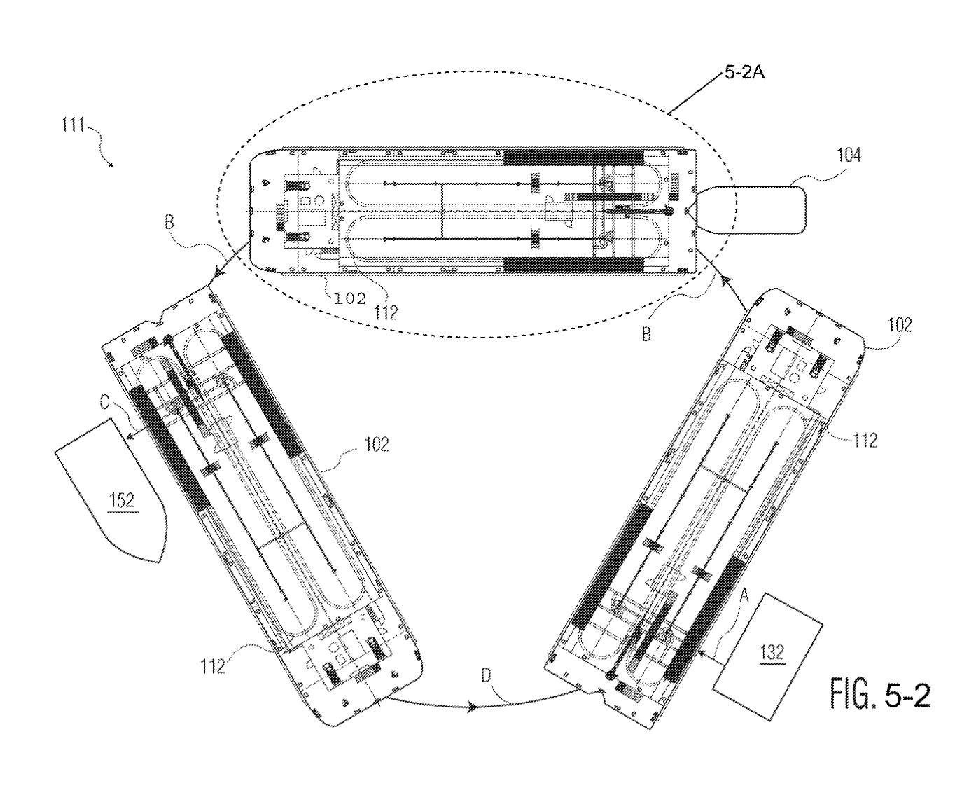

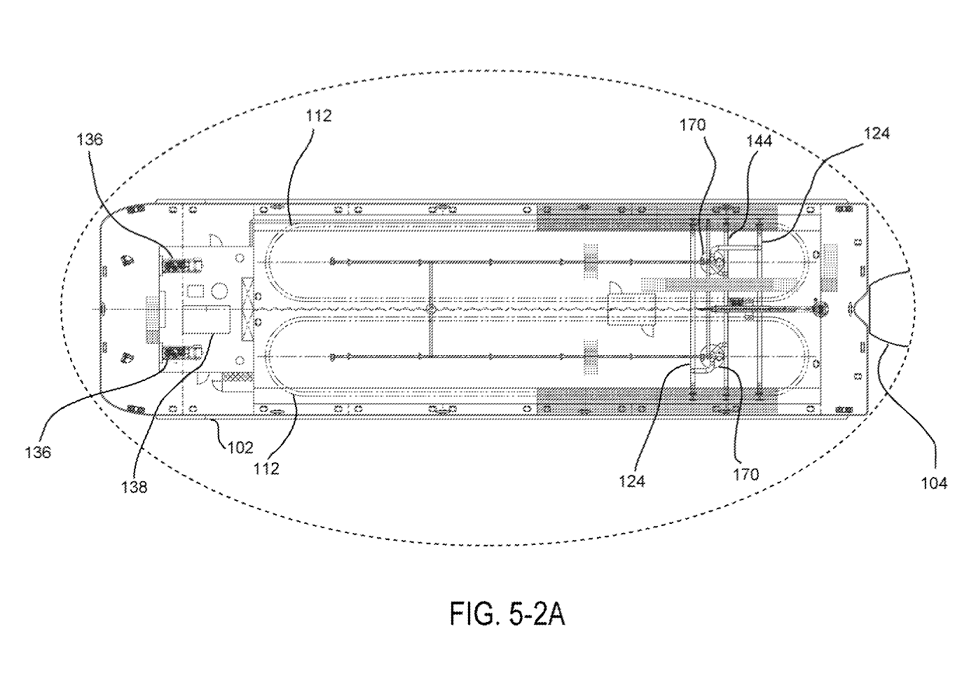

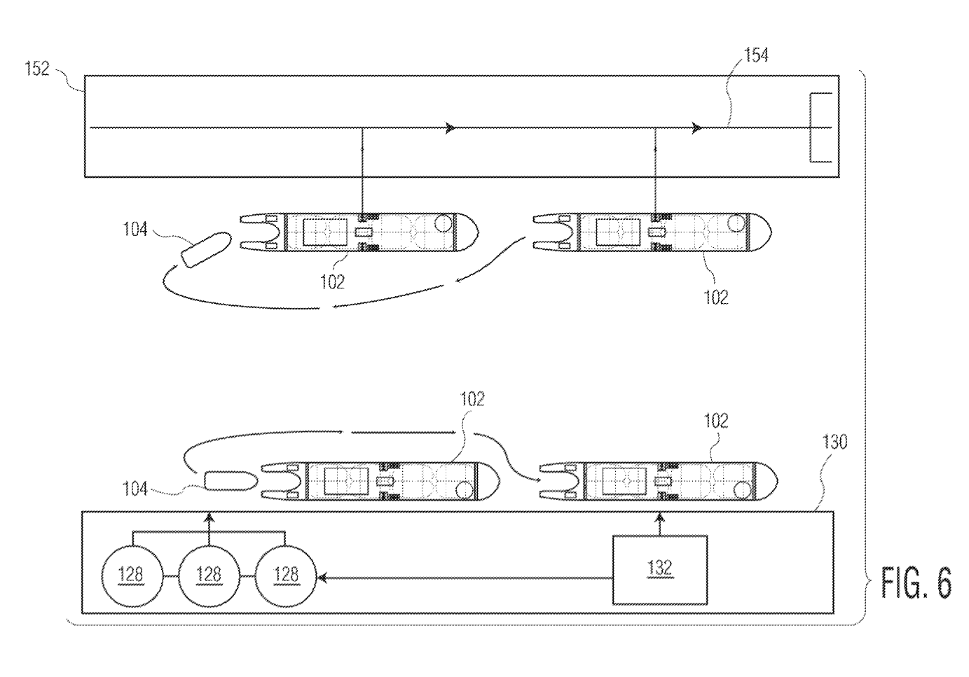

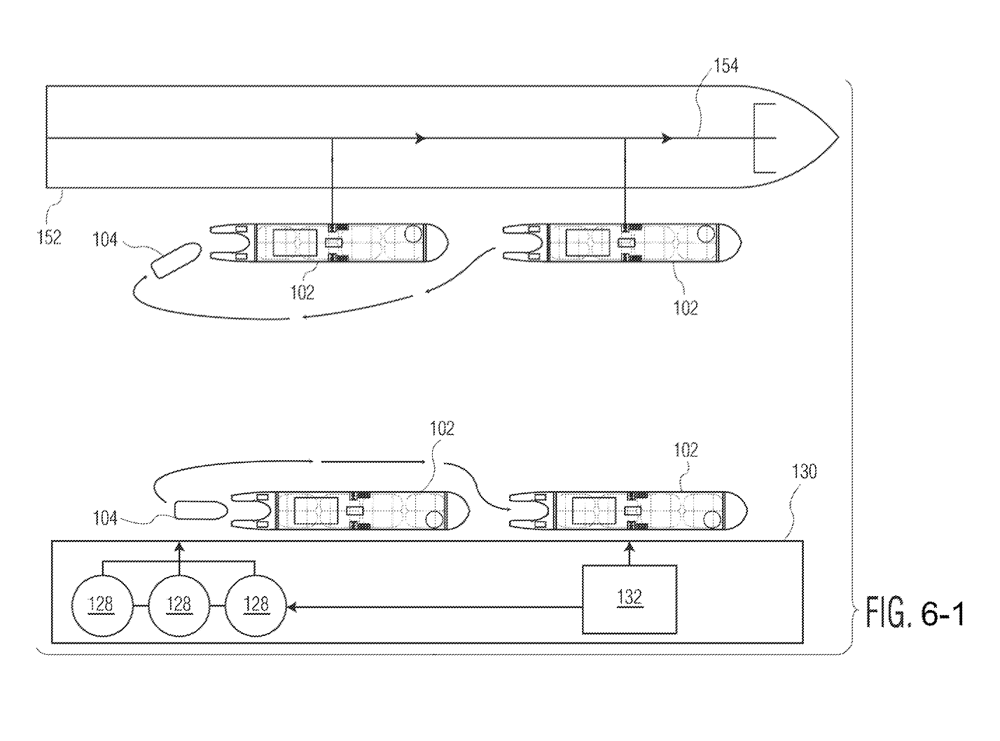

In a preferred embodiment, the liquid header 124 is fluidly connected to an upper manifold 126a and to a lower manifold 126b of each loading manifold 126 (FIG. 4B). The upper manifold 126a (FIG. 4B) is configured for receipt of LNG from the storage tanks 128 of a traditional supply facility 130 (FIG. 6). The lower manifold 126b (FIG. 4B) is configured for the receipt of LNG directly from a liquefaction plant 132 (FIG. 6), obviating the need for LNG storage tanks 128 at a supply facility 130. In effect, the articulated tug and barge arrangement 100 is capable of serving as a transport and storage facility, and acting as an transport terminal ring 111, by the barge unit 102 receiving LNG directly from the liquefaction plant 132, transporting the LNG to the destined off board facilities 152 and employing regasification unit 116 and type C tanks 112 in embodiments of the present invention, as illustrated in FIG. 5.

The heat exchanger 134 of the regasification unit 116 of the present invention may be a shell and tube heat exchanger, a printed circuit heat exchanger, a bent-tube fixed-tube-sheet exchanger, plate-type exchanger, spiral wound exchanger, falling-film exchanger, or other heat exchangers commonly known by those skilled in the art that meet the temperature, volume and heat absorption requirements for the LNG to be regasified.

Considering space limitations onboard the barge unit 102 and cost comparison, the regasification unit 116 preferably uses saturated steam as the direct heating medium. The regasification unit 116 allows the LNG to be pressurized and regasified to the discharge pressure of approximately 30 to 120 bar.

Preferably, one or more dual fuel generators 136 are disposed upon the aft deck of the barge unit 102 and are used to power the barge unit 102 operations, including providing power to the conventional pressure pumps 150 used for water/fluid pumping and circulation as described herein. For instance, suction pumps or single stage centrifugal pumps are frequently used for water/fluid pumping in maritime and industrial applications, and are well known to those skilled in the art. In a preferred embodiment, two cargo pumps of centrifugal design submersible type are disposed within each type C tank 112, one within each lobe, for discharging LNG when necessary. In a preferred embodiment, two suction pumps of centrifugal design are disposed within each type C tank 112, one within each lobe, for transferring LNG to the regasification unit 116.

A nitrogen injection system comprising a nitrogen generator 138 is preferably provided aboard the barge unit 102 to supply nitrogen gas for drying out and inerting the type C tanks 112 before LNG cargo loading or grade changing operations and after discharging cargo. A nitrogen generator is, in effect, an air compressor which pushes air through a permeable membrane and separates nitrogen from air, as would be known to one skilled in the art. The nitrogen generator 138 is fluidly coupled to the type C tanks 112 by an inert gas header 140. Preferably, a deck storage tank 142 for LNG is provided aboard the barge unit 102 and is fluidly coupled to the type C tanks 112 for gassing-up operations, to remove nitrogen from the type C tanks 112 or to remove cargo vapors of the previous cargo. A vapor return line 144 provides a fluid connection between the type C cargo tanks 112 and the loading manifold 126 to maintain tank pressure during loading and discharge operations. As vapor is generated during cool down operations, the vapor return line 144 allows the vapor to be sent from the type C tanks 112 through the manifold 126 to the supply facility 130. While it is preferable to employ a nitrogen generator 138 aboard the barge unit 102, it can be appreciated that an alternative is to employ a nitrogen storage tank aboard the barge unit 102.

A vapor header 146 provides a fluid connection to the regasification unit 116 for send-out or unloading of the natural gas directly from the barge unit 102 at the high pressure vapor discharge manifold 148 to the desired off board facility 152, obviating the need for LNG storage tanks at the destined off board facility 152. The off board facility 152 may be a natural gas pipeline 154 supplying natural gas to consumers, as illustrated in FIG. 6. In effect, the articulated tug and barge arrangement 100 is capable of serving as a transport and storage facility, and acting as an import terminal, by the barge unit 102 employing regasification unit 112 and type C tanks 112 in embodiments of the present invention.

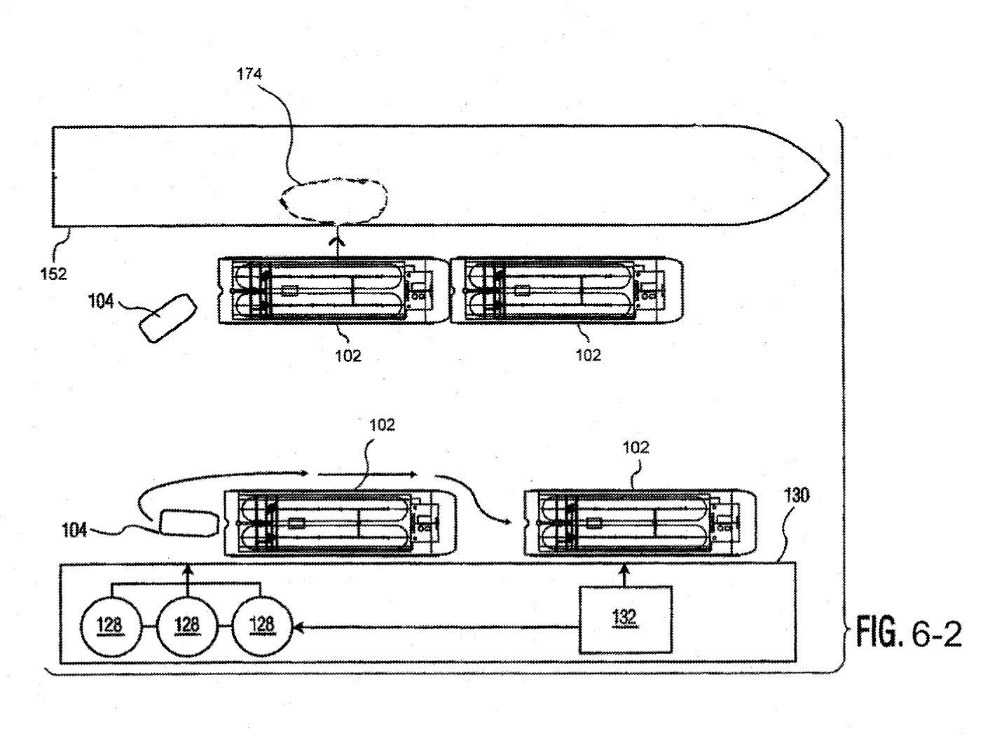

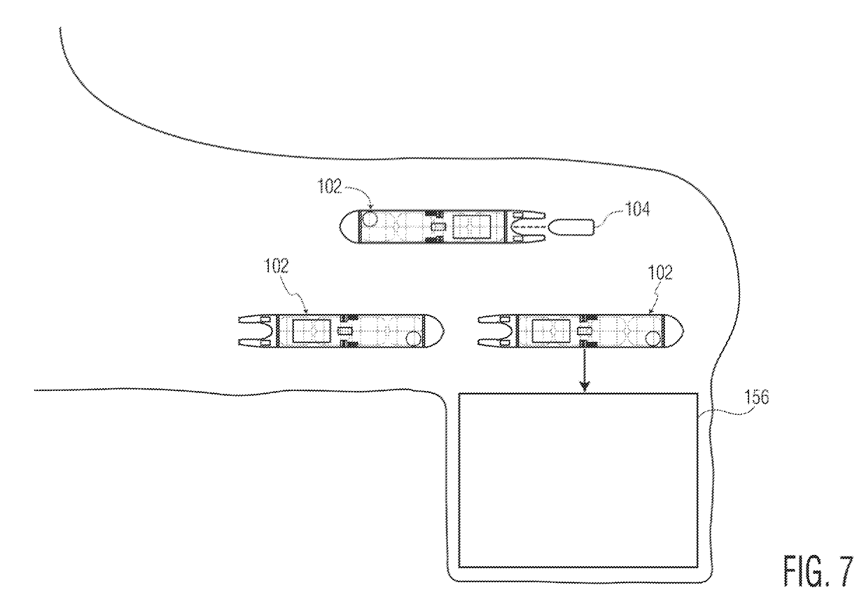

Alternatively, referring to FIG. 7, the off board facility 152 may be a floating power production facility 156, otherwise referred to as a power generation barge or floating power plant (“FPP”), or the off board facility may be a liquefied natural gas fueled ship 152 having an LNG fuel tank 174 as shown in FIG. 5-2 and FIG. 6-2. Since the cost of storing and supplying LNG or natural gas to FPPs such as through the construction and operation of new natural gas pipelines may prove uneconomical, the articulated tug and barge arrangement 100 economically and feasibly achieves this result by serving as a transport, storage and supply facility to the FPP 156, by the barge unit 102 employing regasification unit 112 and type C tanks 112 in embodiments of the present invention. The small size and efficient maneuverability of the articulated tug and barge arrangement 100 enables direct accessibility to FPPs 152 often moored in the protected inland waters such as rivers, lagoons or small ports, as illustrated in FIG. 7. Embodiments of the present invention are customizable to meet the fuel demand of the FPP 156. Moreover, a plurality of barge units 102 may be moored at the FPP, enabling additional reserve storage of fuel for the FPP 156.

Referring to FIG. 5, in a preferred method of operation, LNG is loaded directly from a liquefaction plant 132 through the lower manifold 126b (FIG. 4B) into at least one type C tank 112 disposed within a barge unit 102, obviating the need for LNG storage tanks 128 nearby the liquefaction plant 132. The loading operation is indicated by arrow A. A tug unit 104 is employed to propel the barge unit 102 from the liquefaction plant 132 to an off board facility 152, as indicated by arrows B. LNG is regasified into natural gas aboard the barge unit 102, and the natural gas is transferred to the off board facility 152, as indicated by arrow C, obviating the need for LNG storage tanks at the off board facility 152. The tug unit 104 may thereafter be employed to propel the barge unit 102 from the off board facility 152 to the liquefaction plant 132, as indicated by arrow D. Moreover, in a more preferred method according to another aspect of the invention, one tug unit 104 and three barge units 102 are provided, whereby a first barge unit 102 is undergoing a loading operation (arrow A) at the liquefaction plant 132 while a second barge unit 102 is being transported (arrows B) to an off board facility 152 while a third barge is regasifying LNG and undergoing unloading operations (arrow C) at the off board facility 152, as may be appreciated by illustration in FIG. 5. In effect, the articulated tug and barge arrangement 100 is capable of serving as a transport and regasification facility and provides for a transport terminal ring 111 as exemplified in FIG. 5.

In embodiments of the present invention, as examples, the off board facility 152 may be an offshore floating power production facility, a natural pipeline, and/or an onshore power production facility.

In yet another embodiment of the present invention, a method is provided for transporting and storing LNG. Referring to FIGS. 5, 6 and 7, LNG is loaded directly into a type C tank 112 disposed within one or more barge units 102, at least one tug unit 104 is employed to transport each barge unit 102 to an off board facility 152, and LNG is thereafter stored in the type C tank 112 disposed within the barge unit 102 at the off board facility 152. Since the barge unit 102 can, for example, sufficiently contain the LNG cargo under pressure for up to approximately twenty-one (21) days, in effect, the articulated tug and barge arrangement 100 replaces otherwise necessary storage facilities at the off board facility 152, by employing type C tanks 112 in the articulated tug and barge arrangement 100 in embodiments of the present invention. Moreover, by employing a regasification unit 116 aboard the barge unit 102, LNG may thereafter be regasified into natural gas aboard the barge unit 102 and offloaded from the barge unit 102 to the off board facility 152. By way of example, the off board facility 152 may be an offshore floating power production facility (FIG. 7), a natural pipeline (FIG. 6), and/or an onshore power production facility.

While it has been proposed to use seawater as a heat source for the regasification of LNG aboard an LNG carrier, conventional discharging of the chilled seawater to the surrounding water body can have undesirable impact on the environment.

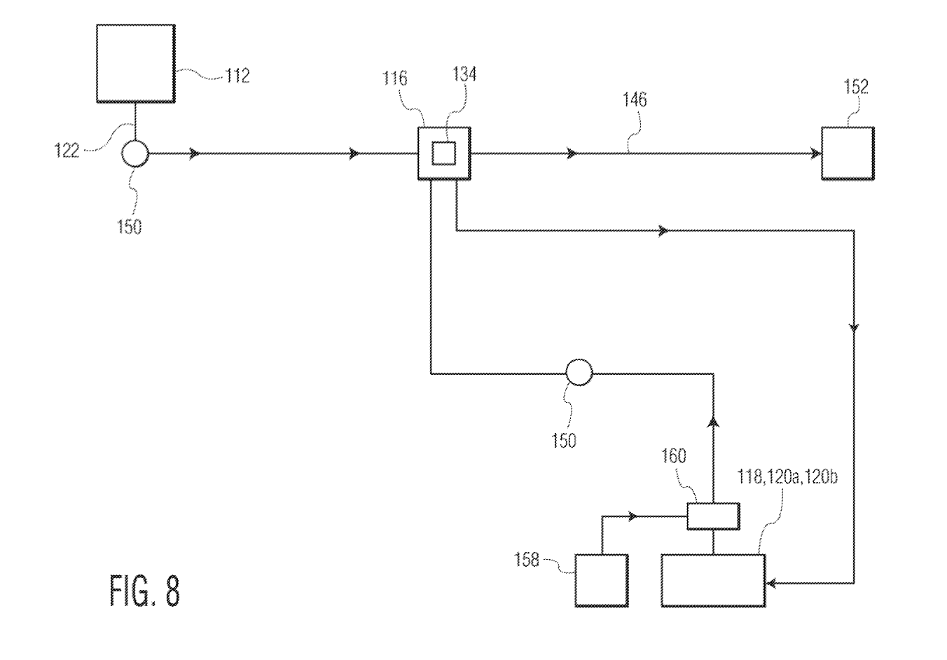

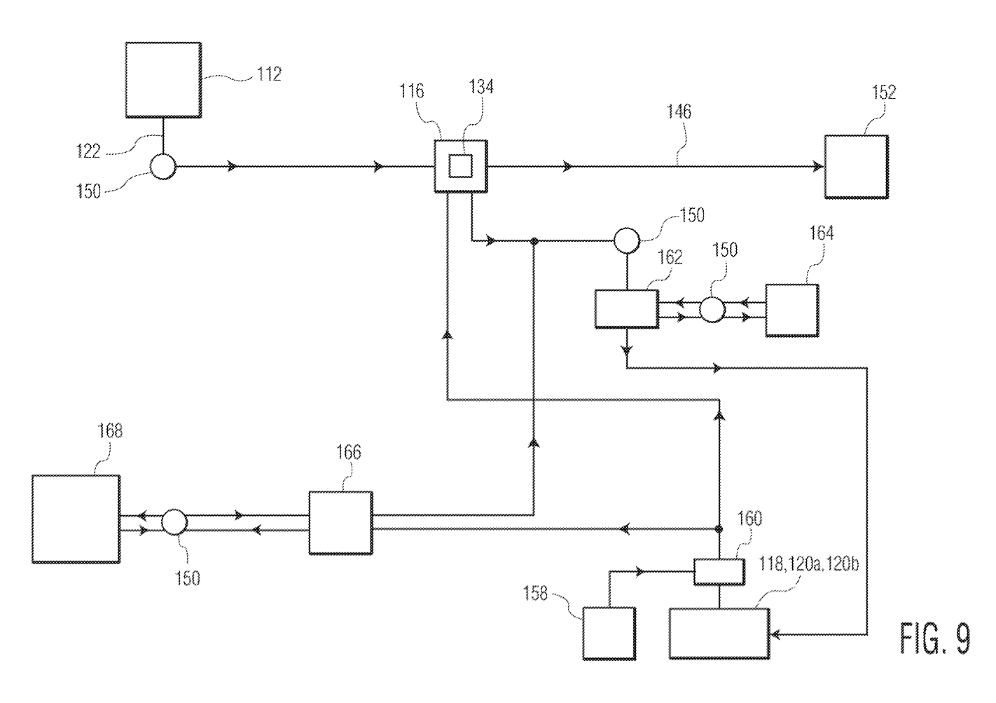

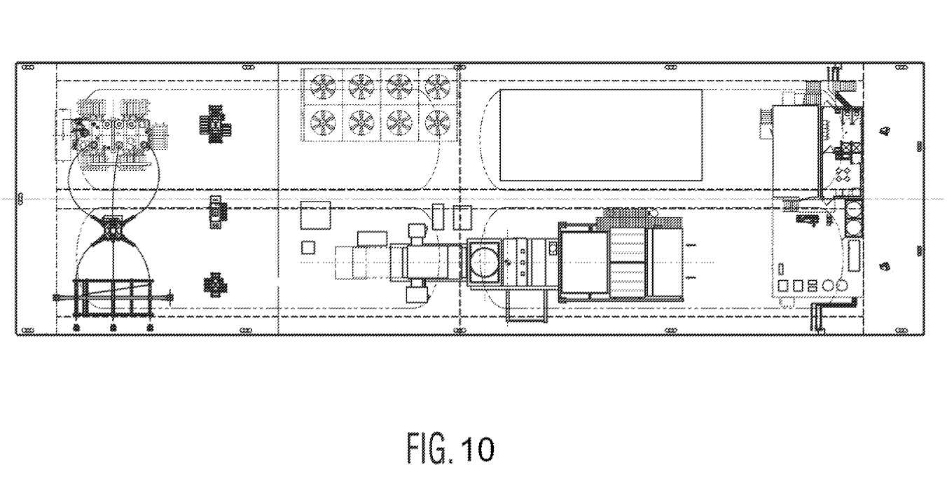

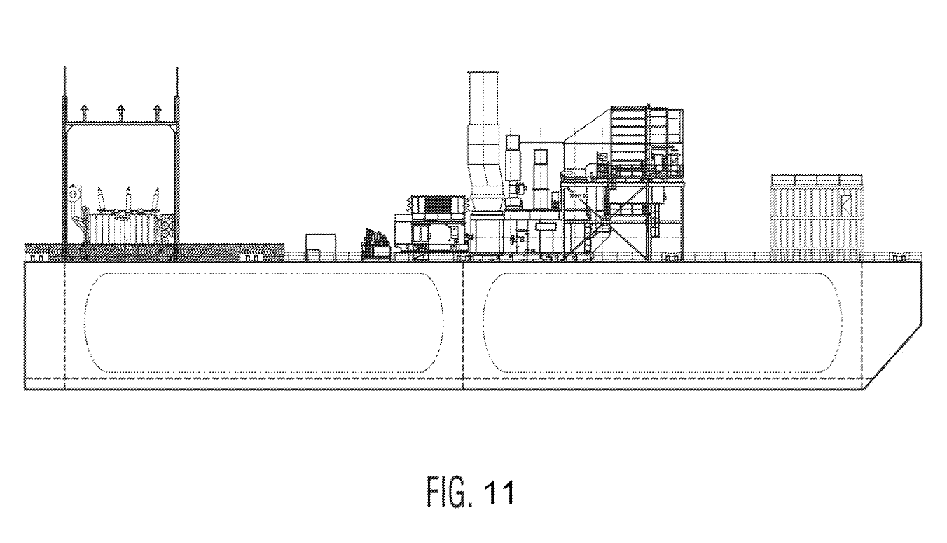

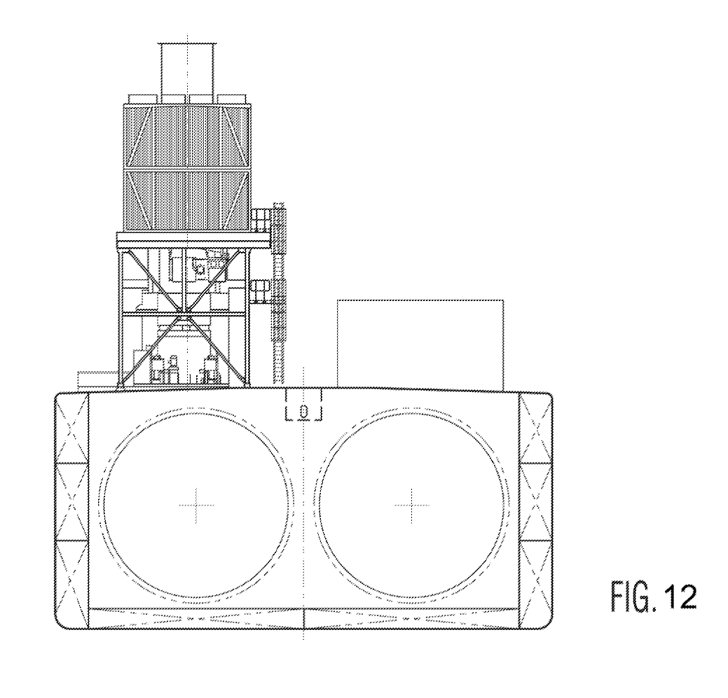

Referring to FIGS. 4A, 4B, and 8, in one preferred embodiment, the barge unit 102 comprises at least one water inlet 158 fluidly coupled to a regasification unit 116, such that seawater may be received through the water inlet 158 and pumped through the heat exchanger 134 disposed within the regasification unit 116 to warm and liquefy the LNG. The barge unit 102 further comprises at least one ballast tank 118 fluidly coupled to the regasification unit 116 such that chilled seawater flowing from the regasification unit 116 may be circulated to the ballast tank 118, as schematically depicted in FIGS. 8 and 9, obviating the discharge of the chilled water into the environment and thereby preventing or mitigating the impact on the environment.

It may be appreciated that the water inlet 158 may be disposed along an external surface of the barge unit 102 or within a sea chest disposed within the barge unit 102.

Preferably, the barge unit 102 further comprises a strainer 160 configured such that seawater may be flowed through the strainer 160 prior to entering the heat exchanger 134 of the regasification unit 116, as schematically depicted in FIGS. 8 and 9.

In one preferred embodiment, the barge unit 102 comprises at least one set of upper ballast tanks 120a, 120b disposed within the barge unit 102 vertically above the draft water line of the barge unit 102, wherein the regasification unit 116 is fluidly coupled to the set of upper ballast tanks 120a, 120b. Providing ballast tanks 120a, 120b above the draft water line of the barge unit 102 mitigates the heat transfer between the chilled ballast water in ballast tanks 120a, 120b and the surrounding water body, thereby further preventing or mitigating the impact on the environment. Moreover, providing chilled water to the ballast tanks 118, 12a, 120b in effect cools down the outer containment system of the barge unit 102 and thereby mitigates boil-off within the type C tanks 112 within the barge unit 102.

In a preferred embodiment, the barge unit 102 receives ballast water at a water inlet 158 and via circulation through the heat exchanger 134 and into the ballast tanks 118, 120a, 120b at a typical rate (e.g., 2000 m³/hour) during the offloading of the regasified cargo (i.e., natural gas) such that positive displacement of the barge unit 102 achieved from ballasting down is offset by negative displacement of the barge unit 102 achieved from offloading the cargo. In a most preferred embodiment, the barge unit 102 receives ballast water via circulation through the heat exchanger 134 and into the ballast tanks 118, 120a, 120b at substantially the same rate as the offloading of the regasified cargo (i.e., natural gas) such that the positive displacement of the barge unit 102 achieved from ballasting down is substantially offset by the negative displacement of the barge unit 102 achieved from offloading the cargo.

Moreover, since ballast tanks 118, 120a, 120b are fluidly coupled to the regasification unit 116, ballast water may also be pumped from the ballast tanks 118, 120a, 120b and circulated through the heat exchanger 134 disposed within the regasification unit 116 to warm and liquefy the LNG and thereafter circulated back to the ballast tanks 118, 120a, 120b, as schematically depicted in FIGS. 8 and 9, in a closed loop system, again obviating the discharge of the chilled water into the environment and thereby preventing or mitigating the impact on the environment.

Referring to FIG. 9, in one preferred alternative embodiment, the chilled seawater flowing from the regasification unit 116 may be circulated through a heat exchanger 162 such as a steam heater in fluid connection with a heating element such as a boiler 164 to warm the chilled seawater. The warmed seawater from the heat exchanger 162 is flowed into ballast tanks 118, 120a, 120b. The temperature of the ballast water entering and stored in the ballast tanks 118, 120a, 120b can thus be controlled. Moreover, the temperature of the seawater flowed into the ballast tanks 118, 120a, 120b may be raised to a point such that it is sanitized (e.g. >165 degrees F.), thereby enabling compliance with ballast water exchange regulations.

Referring to FIG. 9, in yet another preferred embodiment, the seawater received from the water inlet 158 may be pumped through a heat exchanger 166 such as a steam heater in fluid connection with a heating element such as a boiler 168 where the seawater is warmed. It may be appreciated that other heating mediums such as glycol and propane may alternatively be used to heat the seawater received from the inlet 158. The warmed seawater flowing from the steam heat exchanger 166 may be flowed through the regasification unit 116 to warm and regasify the LNG. The steam heat exchanger 166 is preferably a conventional shell and tube heat exchanger and may provide either all or a portion of the heat required for the LNG regasification. In the event that the local seawater temperature is not sufficient to provide the amount of heat required for the desired level of regasification operations, this embodiment of the invention provides operational advantages.

By using ballast water as a primary heat exchange medium for the onboard regasification units 116, embodiments of the present invention safely and efficiently enable regasification, unloading and ballasting operations without discharge to surrounding seawater while providing necessary ballast water to the barge unit 102 thereby offsetting respective displacements.

It will be apparent to persons skilled in the relevant art that various changes in form and detail can be made without departing from the spirit and scope of the invention. While various embodiments of the present invention have been described above, it should be understood that they have been presented by way of example only, and not limitation. Thus, the breadth and scope of the present invention should not be limited by any of the above-described exemplary embodiments, but should only be defined in accordance with the following claims and their equivalents. All patents and publications discussed herein are incorporated in their entirety by reference thereto.

What is claimed is:

1. An articulated tug and barge arrangement for transporting and storing liquefied natural gas (LNG) and bunkering liquefied natural gas to a liquefied natural gas fueled ship, the articulated tug and barge arrangement comprising:
a tug unit comprising a propulsion system;
a barge unit for conveying and storing and bunkering a load of LNG, the barge unit comprising at least one type C tank for conveying and storing the load of LNG under pressure, a gas combustion unit operatively coupled to the type C tank for the management of over pressurized boil-off gas within the type C tank, and an at least one liquid manifold fluidly coupled to bunker LNG from the type C tank to the liquefied natural gas fueled ship;
wherein said tug unit is operatively coupled to said barge unit for propelling said barge unit from one location to another.

2. The articulated tug and barge arrangement of claim 1, the barge unit further comprising an at least one regasification unit fluidly coupled to receive LNG from said type C tank for regasifying LNG aboard the barge unit.

3. The articulated tug and barge arrangement of claim 1, the barge unit further comprising at least one ballast tank having ballast water and at least one regasification unit fluidly coupled to the at least one ballast tank such that the ballast water may be pumped from the ballast tank through a heat exchanger disposed within a regasification unit to warm and regasify the LNG.

4. The articulated tug and barge arrangement of claim 1, the barge unit further comprising at least one ballast tank for the containment of ballast water and at least one regasification unit is fluidly coupled to a water inlet disposed along the exterior surface of said barge unit such that water may be withdrawn from the body of water surrounding said barge unit and circulated through a heat exchanger disposed within said regasification unit to warm and regasify the LNG; and wherein the regasification unit is fluidly coupled to the at least one ballast tank such that water may be flowed from said regasification unit into said ballast tank for ballasting operations.

5. The articulated tug and barge arrangement as in claim 1, further comprising an attachment means for operatively connecting the tug unit to the barge unit.

6. The articulated tug and barge arrangement of claim 1, wherein the propulsion system of the tug unit is powered by LNG.

7. The articulated tug and barge arrangement of claim 1, wherein the barge unit further comprises a nitrogen injection system fluidly coupled to a regasification unit by high pressure piping for adjustment of the calorific value of natural gas unloaded from the barge unit.

8. A tug and barge arrangement for transporting and storing and transferring liquefied natural gas (LNG) to an off board facility, the tug and barge arrangement comprising:
a tug unit comprising a propulsion system;
a barge unit for conveying and transferring a load of LNG to the off board facility for fueling said off board facility, the barge unit comprising at least one type C tank for transporting the load of LNG under pressure, a gas combustion unit operatively coupled to the type C tank for the management of over pressurized boil-off gas within the type C tank, and at least one liquid manifold fluidly coupled to supply LNG from said type C tank to the off board facility;
wherein said tug unit is operatively coupled to said barge unit for propelling said barge unit from one location to another.

9. The tug and barge arrangement of claim 1, wherein the off board facility is a ship fueled by LNG.

10. The tug and barge arrangement of claim 1, wherein the off board facility receives the liquefied natural gas as bunker fuel.

11. The tug and barge arrangement of claim 1, wherein the tug is operatively coupled to said barge unit in an articulated manner.

12. The tug and barge arrangement of claim 1, wherein the tug is operatively coupled to said barge unit in a push-barge manner.

13. A method for transporting and storing liquefied natural gas (LNG) aboard an articulated tug and barge arrangement wherein said tug and barge arrangement comprises a tug unit operatively coupled to a barge unit having at least one type C tank, said method comprising:
loading LNG directly from a liquefaction plant into the or each type C tank disposed within the barge unit;
employing the tug unit to propel the barge unit from the liquefaction plant to a destination of an off board facility;
storing the LNG within the or each type C tank disposed within the barge unit at the destination of the off board facility;
and transferring the LNG to the off board facility as fuel.

14. The method of claim 13, wherein the off board facility is a ship fueled by LNG.

15. The method of claim 13, wherein the off board facility is a ship fueled by natural gas.

16. The method of claim 13, wherein the off board facility is a ship fueled by natural gas, said ship having a regasification for the regasification of LNG onboard the ship.

17. The method of claim 13, wherein the off board facility is a floating power production facility.

18. The method of claim 13, wherein the step of storing the LNG within the or each type C tank lasts up to 21 days.

19. The method of claim 13, further comprising stacking two or more barge units at the destination of the off board facility for while storing the LNG within the or each type C tank disposed within respective barge units.

20. The method of claim 13, further comprising allowing the barge unit to receive ballast while transferring the LNG to the off board facility.

21. A method for transporting and bunkering liquefied natural gas (LNG) fuel to a ship, said method comprising:
loading LNG directly from a liquefaction plant into an at least one type C tank disposed within a barge unit for storing and transporting said LNG;
employing a tug unit to operatively couple said barge unit to propel the barge unit from the liquefaction plant to the ship;
unloading LNG from the at least one type C tank disposed within the barge unit; and
bunkering LNG from the barge unit to the ship for supplying said ship with LNG fuel.

22. The method of claim 21, further comprising stacking two or more barge units at a destination of the ship while storing the LNG within the or each type C tank disposed within respective barge units.

23. A method for transporting and bunkering liquefied natural gas (LNG) fuel to a ship, said method comprising:
loading LNG directly from a liquefaction plant into an at least one membrane tank having a boil off gas management system disposed within a barge unit for storing and transporting said LNG;
employing a tug unit to operatively couple said barge unit to propel the barge unit from the liquefaction plant to the ship;
unloading LNG from the at least one membrane tank disposed within the barge unit; and
bunkering LNG from the barge unit to the ship for supplying said ship with LNG fuel.

24. The method of claim 21, further comprising stacking two or more barge units at a destination of the ship while storing the LNG within the or each membrane tank disposed within respective barge units.
